(19) United States
(12) Patent Application Publication
(10) Pub. No.: US 2012/0287253 A1
(43) Pub. Date: Nov. 15, 2012

(54) AUTOMATIC VISION ALIGNED SCRIBER

(76) Inventors: Jakov Makover, Maccabim (IL); Bar Cochva Mardlx, Tel Aviv (IL); Yaacov Sadeh, Rechovot (IL)

(21) Appl. No.: 13/521,608

(22) PCT Filed: Jan. 5, 2011
(86) PCT No.: PCT/CN2011/070031

§ 371 Date: Jul. 11, 2012

(30) Foreign Application Priority Data
Jan. 13, 2010 (CN) 201010004724.5

(51) Int. Cl. H04N 7/18

(52) U.S. Cl. 348/61; 348/E07.085

(57) ABSTRACT

An automatic vision aligned scriber includes a table, an adsorption orientation device, a bridge, a moving platform, a service controller, a printing head, a camera, a lamp and an image processor. The scriber uses a flat table for placing each footwear assembly waiting for scribing. An image system can identify each footwear assembly and measure its position and orientation on the table. A manipulator is used for controlling the printing head to move above the table and printing the lineation on each footwear assembly according to its special position and orientation relative to the table. The scriber has the advantages of digitalization and space saving.

### BACKGROUND OF THE INVENTION

1. Field of the Invention

The present invention relates to a scriber, and more particularly to a digital and compact automatic vision aligned scriber.

2. Description of the Prior Art

When making shoes, basically, the respective parts (footwear assemblies) of a shoe should be printed or scribed with marks before being assembled together. For example, the respective footwear assemblies of the shoe are printed with logos, patterns or stitch marks along which the respective footwear assemblies are to be assembled together. These printed stitch marks instruct the sewer to sew or glue the footwear assemblies together by following the sew lines, and the printed patterns show the sewer where to sew the decorative pattern (at what position on the footwear assemblies the decorative pattern should be sewn). Currently, there are two methods for scribing a stitch mark, one of the methods is to prepare a slotted template, then put the template at a precise position on the footwear assemblies, and then use a pencil to draw the stitch mark on the footwear assemblies by moving the pencil along the slots of the template. Another method is to put a silk screen with open areas on the footwear assemblies, and the silk screen is precisely positioned with respect to the footwear assemblies, finally ink or other printable materials is pressed put on the silk screen and pressed through the open areas so as to leave the stitch mark on the footwear assemblies.

Both of the above methods are labor intensive due to the fact that it is time-consuming to put the shoe template or the silk screen precisely at the designated positions on the footwear assemblies. Furthermore, it should repeatedly put footwear assemblies of shoes at precise positions on a table as quickly as possible, each position should be surrounded by blocks, and then the shoe template or the silk screen should be placed in alignment with the footwear assemblies, so that the shoe template an the silk screen can be moved from one footwear assembly to another footwear assembly. However, it still costs a lot of time to prepare the precise positions of the respective footwear assemblies on the table and to adjust the positions of the blocks with respect to the footwear assemblies. Bad consequence will occur if want to save time. Marking the stitch mark with the above methods requires the factory to have a large area for many tables loaded with many footwear assemblies, thus increasing the cost of purchasing real estate.

Another disadvantage is that it needs to produce various shoe templates or silk screens for the respective footwear assemblies of different sized left and right shoes. Any style of shoes may involve the use of hundreds of templates, which not only increases the production cost, but requires a large warehouse to store the templates. Moreover, picking out the needed templates from the sea of templates may also cause cost increase.

A third disadvantage is that the above methods need to be carried out in a hall (big room) of a factory, namely, all the footwear assemblies required for making shoes must flow through the hall, which contradicts the notion that it should try to minimize inventory and use flexible slanting production line during production.

The present invention has arisen to mitigate and/or obviate the afore-described disadvantages.

### SUMMARY OF THE INVENTION

The primary object of the present invention is aimed at solving all the abovementioned disadvantages by providing an automatic vision aligned scriber, wherein the footwear assemblies can be automatically scribed or printed by a small computerized scriber or printer without using shoe templates or silk screen. The present invention is further capable of using image to identify and locate the positions of the footwear assemblies, so that the patterns or stitch marks can be printed or scribed at accurate positions on the respective footwear assemblies, without having to make the footwear assemblies precisely fixed on the printing surface. The printing or scribing is performed by an inkjet printer which includes a flat table and a printing head mounted on a manipulator, and the manipulator is capable of moving the printing head along the path which covers the entire area of the table.

To achieve the above object, the automatic vision aligned scriber in accordance with the present invention comprises:

a table for carrying footwear assemblies, on the table being mounted two rails;

an adsorption orientation device for adsorbing the footwear assemblies to the table;

a bridge movably mounted on the rails, bestriding over the table, and being driven to move linearly along the rails;

a moving platform movable mounted on the bridge and driven to move linearly;

a service controller for controlling the linear motion of the bridge and the moving platform;

a printing head assembled to the moving platform;

a camera mounted on the platform;

a lamp mounted on the platform;

an image processor connected to the camera for digitization and storage of images taken by the camera, the images covering the entire area of the table, wherein database of digital geometry of all the available footwear assemblies corresponding to patterns to be printed are saved in advance in the image processor, and the database is used to implement an image-matching program, so as to locate the positions of the footwear assemblies on the table, the automatic vision aligned scriber uses a computer to perform printing by using predetermined geometry patterns, the computer calculates the real positions of the footwear assemblies with respect to the patterns to be printed, thus producing an actual printing program of the footwear assemblies, the actual printing program is implemented by the automatic vision aligned scriber, the printing head is driven to move on the table to perform printing at the positions calculated by the printing program.

The automatic vision aligned scriber in accordance with the present invention further includes an image processor which is provided with a digital camera, an image processing computer and an image analysis software. The digital camera is assembled to the movable printing head. Before printing, when the footwear assemblies are positioned at any arbitrary positions on the table, the camera takes a set of images covering the entire area of the table. The images are processed by the image processing computer. Define the geometries of all the footwear assemblies and the relation between the geometries of all the footwear assemblies and the stitch marks, the image analysis software can identify the respective footwear assemblies based on their unique geometry parameters, and the locates the position and orientation of the footwear assemblies based on the positions of the geometries of the footwear assemblies. Finally, the image analysis software can move or change the stitch marks to fit the arbitrary positions of the footwear assemblies. When all the patterns and stitch marks are reset, patterns will be printed with tiny drops of ink at the final position at which the geometry patterns need to be printed.

The printing head driver can move the printing head all over the table to release tiny drops of ink to print out the patterns at the positions where the footwear assemblies are located.

The footwear assemblies can be fixed on the table by many ways, such as vacuum suction or electrostatic adsorption. The electrostatic field is produced from an isolation layer displayed on the table by using DC high voltage current. The present invention is capable of continuously printing when the printed footwear assemblies are being removed from the table and unprinted footwear assemblies are being placed on the table. The design is such that the printing is performed at one half of the table while the operator put the unprinted footwear assemblies on another half of the table.

To better understand how the present invention overcomes the disadvantages of the conventional art, the geometry data of the present invention is digital. Therefore, the present invention doesn't need to use shoe templates or silk screens, and according doesn't require a large area to store the hundreds of templates. Furthermore, the printing device is as small as an office desk, and the printing device can be operated by only a single operator and has a capacity same as the workload of several operators using conventional methods. Therefore, the present invention is truly labor-saving, as compared to the conventional method that requires the footwear assemblies to be put at precise positions in a large ground area, and then the footwear assemblies are manually marked one by one by using a template.

### BRIEF DESCRIPTION OF THE DRAWINGS

FIG. 1 is a flow chart showing an automatic vision aligned scriber in accordance with the present invention;

FIG. 2 is an assembly view of the automatic vision aligned scriber in accordance with the present invention;

FIG. 3 is a perspective view showing a table of the automatic vision aligned scriber in accordance with the present invention; and

FIG. 4 is an illustrative view of a part of FIG. 3.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

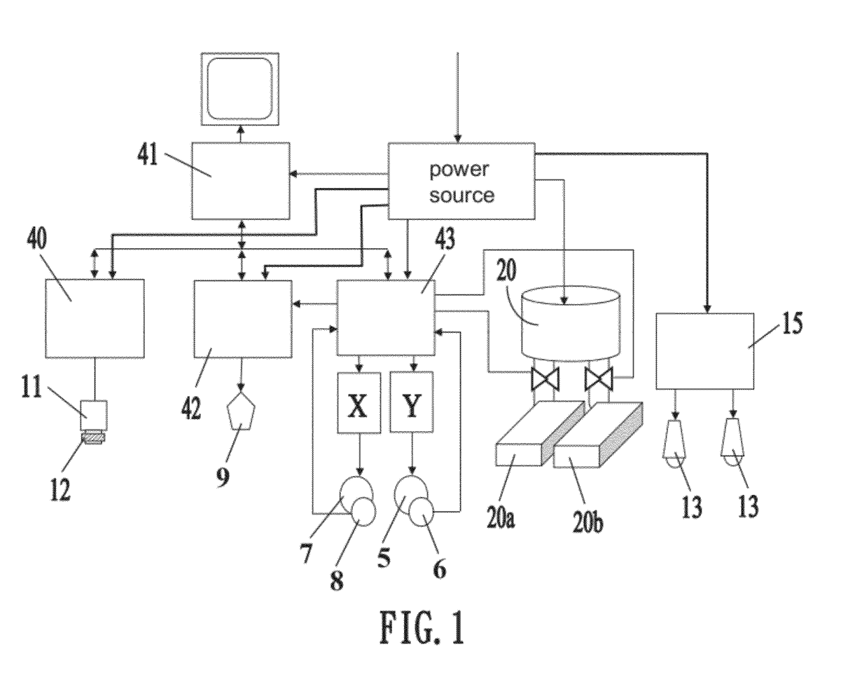

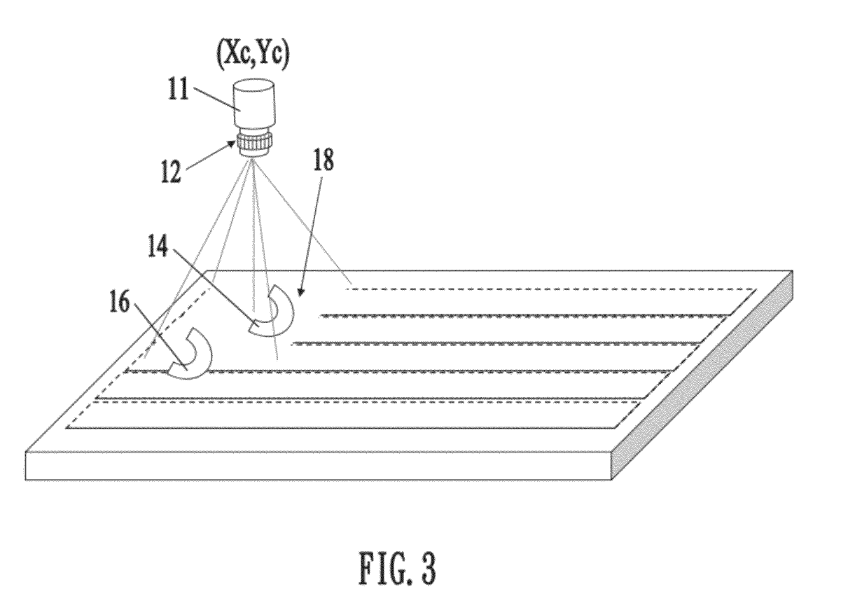

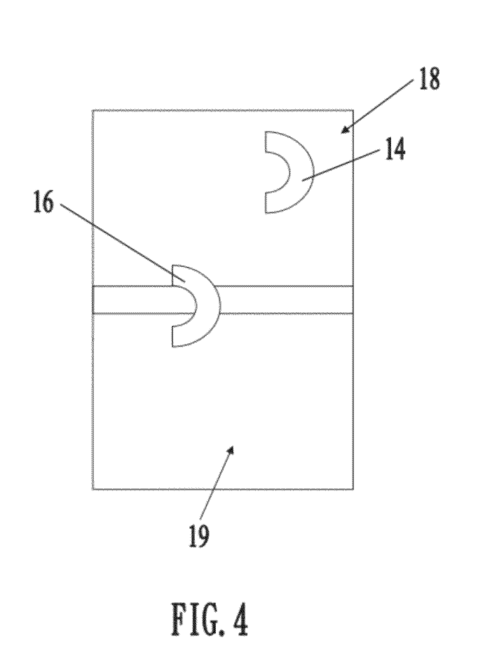

Referring to FIGS. 1-4, an automatic vision aligned scriber in accordance with the present invention includes a table 20, an adsorption orientation device, a bridge 4, a moving platform 10, a service controller 43, a printing head 9, a camera 11, a lamp 13 and an image processor 40.

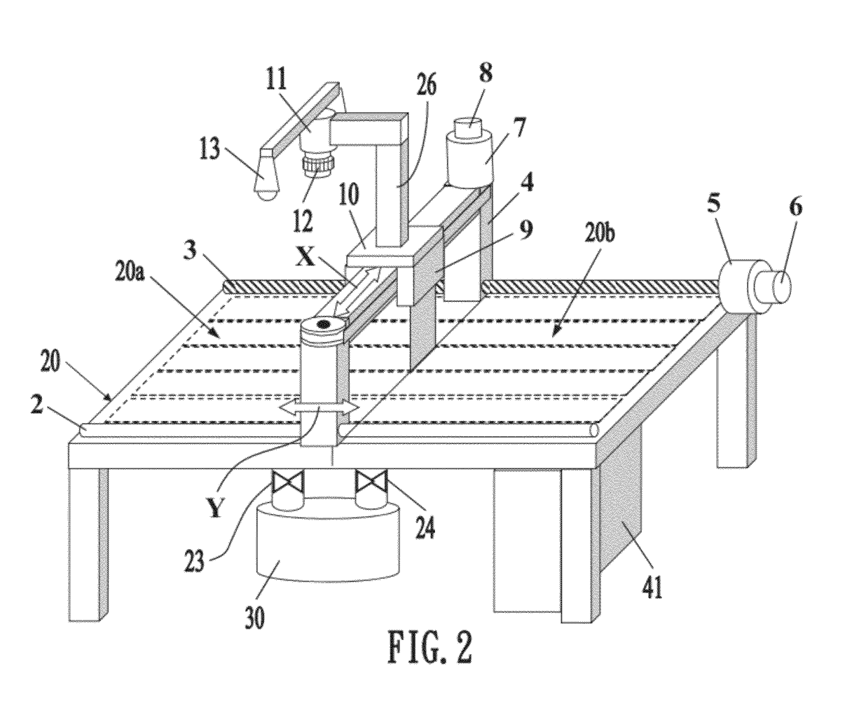

The table 20 is used to carry the footwear assemblies 14 and 16, which are adsorbed to the table 20 by the adsorption orientation device (such as a vacuum pump 30) and wait to be printed, as shown in FIG. 2.

The printing head 9 is assembled to the moving platform 10, and the moving platform 10 is movably mounted on the bridge 4 and capable of moving in the direction Y together with the bridge 4 and further capable of sliding along the bridge 4 to move in the direction X to across the table 20, so that the printing head 9 can cover the entire area of the table 20. It is to be noted that the moving and orientation of the bridge 4 in the direction Y is controlled by a motor 5 and a position feedback encoder 6, and the moving and orientation of the moving platform 10 in the direction X is controlled by a motor 7 and a position feedback encoder 8. The bridge 4 bestrides over the table and is driven to move linearly along the rails 2, 3 mounted on the table 20. In this embodiment, the rail 3 is a screw to be rotated by the motor 5, which consequently causes the movement of the bridge 4. Similarly, the platform 10 can also be driven to move linearly by the motor 7.

The table 20 can also be equally divided into two halves 20a and 20b, each of which is connected to the vacuum pump 30 by a vacuum pipe line (not shown), and two electrically controlled valves 23, 24 are selectively used to control the vacuum pump, so that the vacuum pump can be control to selectively produce vacuum on the two halves 20a or 20b of the table 20.

A digital camera 11 with a lens 12 is mounted on a pillar 26 which is assembled on the moving platform 10, so that the camera 11 is able to move on the table 20 in the directions X and Y. The camera 11 includes a visible area 18 which covers a part of the table 20. It is to be noted that the camera 11 can be set into a stationary mode, in which the camera 11 is fixed with respect to the table 20, and the visible area 18 covers the entire area of the table 20. Or, there can be several cameras 11 all fixed with respect to the table 20, and the visible areas of the cameras 11 add up to the entire area of the table 20.

The lamp 13 is assembled onto the pillar 26 and moves together with the camera 11, so that the lamp 13 can be driven by a lamp driver 15 to illuminate the visible area 18 of the camera 11 all the time.

The digital database of the geometry of the various available footwear assemblies and the combined geometry of the stitch marks of the footwear assemblies are all digitized and saved in the memory of an image processor 40 in advance. The digital database can be obtained from the computer-aided shoe design system, such as the Delcam.

What mentioned above is the summary of the positional and structural relations of the main components of the present invention.

For a better understanding of the operation of the automatic vision aligned scriber of the present invention, please refer to FIGS. 1-4. The respective footwear assemblies, such as the footwear assemblies 14, 16, are all placed at arbitrary positions on the table 20, once the footwear assemblies 14, 16 are placed on the table, they will be adsorbed to the table 20 by the vacuum suction produced by the vacuum pump 30. Then, the camera 11 will move to the first position (X_{c}, Y_{c}), at which, the camera 11 can cover the visible area 18 and take a picture of the visible area 18. After that, the camera 11 is moved to the next position to cover the visible area 19 and take a picture. Hence, the camera 11 can be moved to a series of positions to take a picture at each position, then the pictures can be digitized and saved in the image processor 40, and finally, the pictures can add up to cover the entire area of the table 20. The image processor 40 then will analyze the digital pictures by using picture-matching rule systems. The rule systems are known and commercially available from many companies, such Matrox of Canada and Cognex of America, and can be used to search between the various footwear assemblies on the table 20 and the digital geometries of all the available footwear assemblies, and the available footwear assemblies are saved in advance in the memory of the image processor 40. Once a matched digital geometry is found, the picture-matching rule system can identify and locate the position and orientation of all the footwear assemblies 14, 16 on the table 20.

The position data of the footwear assemblies 14, 16 is transmitted from the image processor 40 to a main system computer 41, and then the main system computer 41 calculates the geometry changes of each stitch mark with respect to the corresponding footwear assembly, just like putting the stitch marks on the table 20. The main system computer 41 is further capable of transferring the newly calculated geometries of the stitch marks to a printing program based on the coordination system of the table 20, so that the geometries can be printed on the footwear assemblies 14 and 16, and each of geometries is precisely scribed on the corresponding footwear assemblies 14 and 16, just like putting the geometry at any arbitrary position on the table 20.

The printing program is downloaded to a printing head driver 42 from the main system computer 41, and the printing head driver 42 is capable of receiving the position data of the printing head 9 directly from a XY service controller 43. The main system computer 41 orders the service controller 43 to move the printing head driver 42 by turning on the path on the table 20, and the path will finally cover the entire area of the table 20. When the printing head driver 42 moves, it can receive position data from the service controller 43 to perform printing based on the data of the printing program downloaded from the main system computer 41.

To make the scriber of the present invention has better utility, the table 20 can be divided into two halves 20a and 20b which can work independently by using vacuum suction to fix the footwear assemblies 14, 16, so that manipulator can download new footwear assemblies waiting for scribing (printing) onto one of the two halves of the table 20, and another of the two halves of the table 20 can continue to perform printing, in other words, the present invention is capable of continuously and simultaneously carrying out the operations of printing and loading the footwear assemblies.

In general, the structure disclosed in the embodiment of the present invention overcomes all the disadvantages of the conventional art, wherein the footwear assemblies can be automatically scribed or printed by a small computerized scriber or printer without using shoe templates or silk screen. The present invention is further capable of using image to identify and locate the position and orientation of the footwear assemblies, so that the patterns or stitch marks can be printed or scribed at accurate positions on the respective footwear assemblies, without having to make the footwear assemblies precisely fixed on the printing surface.

While we have shown and described various embodiments in accordance with the present invention, it is clear to those skilled in the art that further embodiments may be made without departing from the scope of the present invention.

What is claimed is:

1. An automatic vision aligned scriber comprising:
a table for carrying footwear assemblies, on the table being mounted two rails;
an adsorption orientation device for adsorbing the footwear assemblies to the table;
a bridge movably mounted on the rails, bestriding over the table, and being driven to move linearly along the rails;
a moving platform movable mounted on the bridge and driven to move linearly;
a service controller for controlling the linear motion of the bridge and the moving platform;
a printing head assembled to the moving platform;
a camera mounted on the platform;
a lamp mounted on the platform;
an image processor connected to the camera for digitization and storage of images taken by the camera, the images covering the entire area of the table, wherein database of digital geometry of all the available footwear assemblies corresponding to the footwear assemblies placed on the table, and the database is used to implement an image-matching program, so as to locate the positions of the footwear assemblies on the table, the automatic vision aligned scriber uses a computer which is connected to the image processor to perform printing by using predetermined geometry patterns, the computer calculates the real positions of the footwear assemblies with respect to the patterns to be printed, thus producing an actual printing program of the footwear assemblies, the actual printing program is implemented by the automatic vision aligned scriber, the printing head is able to receive position data of the printing head from the service controller and is driven to move on the table to perform printing at the positions calculated by the printing program.

2. The automatic vision aligned scriber as claimed in claim 1, wherein the adsorption orientation device is a vacuum pump to adsorb the footwear assemblies to the table.

3. The automatic vision aligned scriber as claimed in claim 1, wherein the adsorption orientation device is an electrostatic field which is produced from an isolation layer displayed on the table by using DC high voltage current.

4. The automatic vision aligned scriber as claimed in claim 1, wherein the table is equally divided into two halves, and vacuum suction is produced on the two halves, respectively.

5. The automatic vision aligned scriber as claimed in claim 1, wherein the camera is set into a stationary mode, in which the camera is fixed with respect to the table and has a visible area covering the entire area of the table.

6. The automatic vision aligned scriber as claimed in claim 1, wherein several cameras are set into a stationary mode and fixed with respect to the table, and visible areas of the cameras add up to the entire area of the table.
